(19) United States
(12) Patent Application Publication
(10) Pub. No.: US 2005/0005863 A1
(43) Pub. Date: Jan. 13, 2005

(54) Distillers solubles as the primary constituent in protein blocks for livestock

(76) Inventor: Tracy Aurora Christine Snider, Chesterfield, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/889,534

(22) Filed: Jul. 12, 2004

Related U.S. Application Data
(60) Provisional application No. 60/486,494, filed on Jul. 10, 2003.

(51) Int. Cl. A01K 1/10

(52) U.S. Cl. 119/51.01

(57) ABSTRACT

This invention is a method for making protein blocks for livestock feeding by mixing together distillers solubles, molasses, and tallow, wherein the distillers solubles constitute the primary ingredient in the protein block and the molasses are only a minor constituent of said protein block; removing water from the mixture of distillers solubles, molasses, and tallow using heat and vacuum, so as to condense the mixture; combining the condensed mixture of distillers solubles, molasses, and tallow with premixtures of vitamins, minerals, and other nutrients; pouring the combination of condensed distillers solubles, molasses, and tallow plus nutrient premixtures into molds while the combination is still hot; and cooling the combination to form a protein block.

### CROSS-REFERENCE TO RELATED APPLICATIONS

This application claims the benefit of U.S. provisional application No. 60/486,494 filed Jul. 10, 2003.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to the manufacture of protein feed blocks for livestock and, more particularly, to the use of corn distillers solubles as the primary constituent in this process.

2. Related Art

Distillers solubles and grains are constituents of the stillage that is a by-product of ethanol production. These stillage by-products contain many nutrients including high protein levels. While the grain portion of the stillage has been extensively utilized as an animal feed product, the demand for solubles has been limited and thus the price paid to distilleries has been low. Furthermore, the demand for distillers solubles that are the by-products of dry-grind ethanol production has been much lower than the corresponding by-products of wet mill ethanol production. To increase the usefulness, demand, and thus the price paid for dry-grind distillers solubles, herein are described protein blocks for livestock feeding which incorporate distillers solubles as the primary constituent as well as the methods for making such protein blocks.

U.S. Pat. No. 6,440,478 B1 to Benton et al. teaches a method of making feed blocks involving heating and evaporation of water from a syrup mixture while under vacuum; the problem of feed blocks absorbing moisture in high humidity environments; the need for physical stability of the feed blocks; the degradation of sugars, vitamins, and other nutrients by heat during processing of the feed block materials; the addition of lipid (lecithin) to the feed block mixture; the control of temperature as a variable in feed block formation, including the effect of temperature on the Maillard reaction; the forming of heated and condensed syrup mixtures into feed blocks for livestock; and the cooling of the formed blocks to produce the final product.

U.S. Pat. 5,260,089 to Thomberg teaches a method of making feed blocks which are substantially free of molasses; and of making feed blocks containing distillers grains and solubles wherein nutritional supplements make up less than half of the total weight of the block.

U.S. Pat. No. 4,631,192 to Mommer et al. teaches both continuous flow and batch mixing processes for making feed blocks; pouring of heated material into containers for forming into feed blocks; and addition of vitamins and other nutrients as minor constituents of the feed block material.

U.S. Pat. No. 4,349,578 to Wright et al. teaches the difficulties of using molasses as a feed block binding material; the use of high percentages of dried steep liquor concentrate from wet mill ethanol production in making animal feed blocks; and the need for feed blocks to withstand field conditions without weathering and cracking.

U.S. Pat. No. 3,961,081 to McKenzie teaches a batch mixing method for making feed blocks; heating of the feed material in the presence of reduced vacuum to remove excess water; and the pouring of heated material into molds with subsequent cooling and hardening into feed blocks.

U.S. Pat. No. 4,089,701 to Shimizu et al. teaches a batch mixing process for making feed blocks; addition of fats, oils, and esters of fatty acids to feed block mixtures; and the heating of the feed material under reduced pressure to remove water and concentrate the mixture.

U.S. Pat. No. 4,234,608 to Linehan teaches the addition of tallow to animal feed blocks containing molasses, vitamins, and other nutrients.

U.S. Pat. No. 5,789,001 to Klopfenstein et al. teaches the addition of lipids to feed blocks; and the effects of pH, temperature, moisture, and time on the progression of the Maillard reaction in the manufacture of feed blocks.

U.S. Pat. No. 3,952,115 to Damico et al. teaches the use of additives to control Strecker degradation and the Maillard reaction in the processing of cereal grains into animal feed products.

### SUMMARY OF THE INVENTION

An aspect of the present invention is to provide a method for using distillers solubles as the primary constituent in making protein blocks for livestock feeding.

In accordance with the above aspect of the invention, there is provided a method for making protein blocks for livestock feeding by mixing together distillers solubles, molasses, and tallow, wherein the distillers solubles constitute the primary ingredient in the protein block and the molasses is only a minor constituent of said protein block; removing water from the mixture of distillers solubles, molasses, and tallow using heat and vacuum, so as to condense the mixture; combining the condensed mixture of distillers solubles, molasses, and tallow with premixtures of vitamins, minerals, and other nutrients; pouring the combination of condensed distillers solubles, molasses, and tallow plus nutrient premixtures into molds while the combination is still hot; and cooling the combination to form a protein block.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 schematically illustrates the production of various stillage by-products following the fermentation of grains to make ethanol.

FIG. 2 schematically illustrates the production of protein blocks.

FIG. 3 illustrates the steam jacketed kettle used to heat the mixture under reduced pressure.

### DETAILED DESCRIPTION OF THE PREFERRED EMBODIMENTS

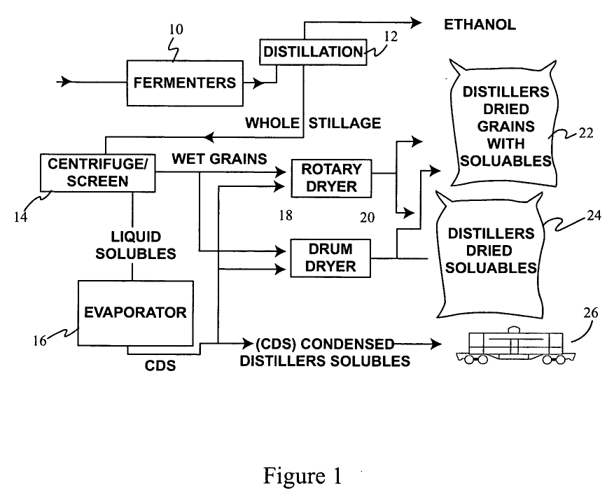

Referring to the accompanying drawings in which like reference numbers indicate like elements, FIG. 1 illustrates the steps that are taken in the process in which fermenters 10 ferment grains to the subsequent distillation 12 of ethanol to the production of various by-products from the whole stillage that remains after distillation. By the use of centrifuges or screens 14, wet grains are separated from liquid solubles. The liquid solubles may be concentrated in an evaporator 16 so as to remove some of the water content. The resulting condensed distillers solubles (CDS) can then either be used in that form 26, or may be used as inputs to other processes. In particular the CDS may be combined with wet grains from the stillage and then dried in a rotary drier 18 or a drum dryer 20. The products of the drying process may be distillers dried grains with solubles 22 or, in the absence of added grains, distillers dried solubles 24.

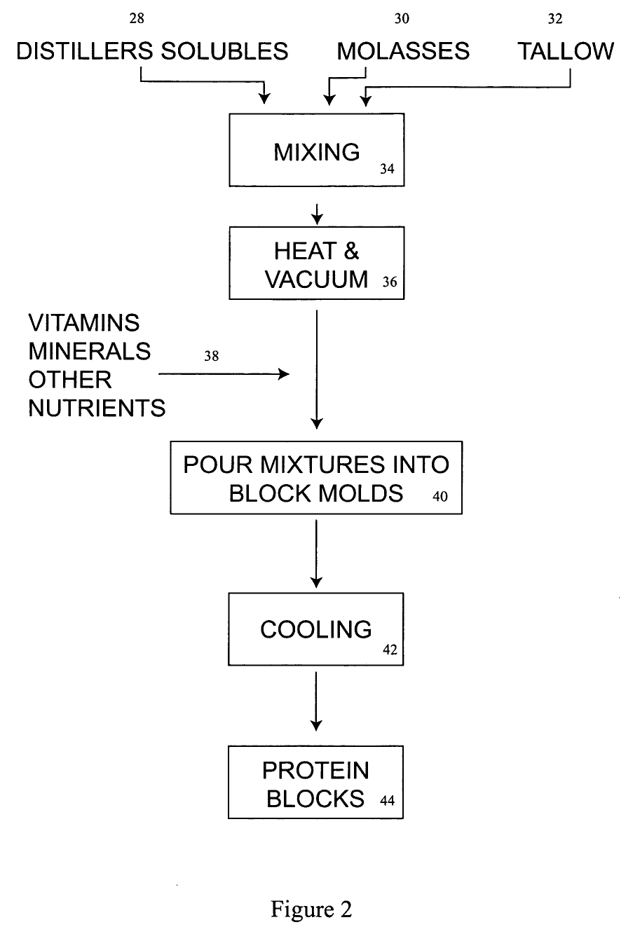

FIG. 2 illustrates the production of protein blocks. Liquid solubles, distillers dried solubles, and condensed distillers solubles (collectively 28) are combined with molasses 30 and tallow 32 and the resulting syrup mixture is dehydrated using techniques that are standard in the block manufacturing industry. This step is indicated at 34 in FIG. 2.

The standard technique, which is well-known in the industry, is as follows. The mixture is heated under reduced pressure 36 so as to promote the evaporation of water and the concentration of the mixture. The mixture is dried to a point where it is thick and viscous with a consistency similar to that of taffy. At this point additional ingredients such as vitamins, minerals, and proteins are added to the concentrated mixture so that such additives constitute less than half of the mixture while the evaporated syrups make up greater than one half of the final mixture. This step is indicated at 38 in FIG. 2. The mixture of evaporated syrups plus additives is then poured while hot into containers, indicated at 40. in FIG. 2, where it is cooled, indicated at 42 in FIG. 2, and formed into blocks, indicated in at 44 in FIG. 2. The blocks are preferably between ten and two hundred fifty pounds. This step is indicated at 40 in FIG. 2. The mixture can also be subjected to pressure during block formation to improve the consistency of the blocks.

In a preferred embodiment, distillers solubles from dry grind ethanol production serve as a replacement for nearly all or all of the molasses as a block ingredient. Distillers solubles are a good replacement for molasses because such solubles have a consistency that is very similar to that of molasses.

Distillers solubles from a variety of sources can be used as starting material for making the protein blocks described herein. Solubles from either wet mill or dry grind ethanol production can be mixed with molasses and tallow, as described above, prior to the dehydration step. The molasses may be virtually any molasses including but not limited to cane molasses and beet molasses. The molasses is preferably beet molasses because it is the most “forgiving”, or easily mixed/and palatable, of liquids. The solubles can be by-products of ethanol production either for the beverage industry or from fuel-grade or other industrial-grade ethanol. The solubles can be in the form of liquid solubles, condensed distillers solubles, or distillers dried solubles. In addition, solubles from the fermentation of other grains, including but not limited to wheat, barley, sorghum, and rice, can be used to make the protein blocks described herein. It is important to note, however, that the grain by-products, if any, that are used will constitute only a minor portion of the final protein block, while the solubles will constitute the primary ingredient, preferably more than half of the weight of the final protein block. In addition, it is emphasized that the object of the present invention is to replace molasses completely, or to the furthest extent possible, as an ingredient of protein blocks. Therefore, higher concentrations of distillers solubles, also known as “tubs”, may be used.

The process of making protein blocks, which are also commonly referred to as feed blocks, as described herein can be carried out batch-wise or through continuous flow processing. The depth of vacuum used during the dehydration process can be varied to control the rate and final extent of water loss from the distillers solubles mixture. The process can be varied to accommodate various packaging needs.

The physical properties of the protein blocks are important. The blocks must be capable of being stored at ambient conditions for prolonged periods and must also be able to withstand varied weather conditions in the field. Especially under conditions of high temperature and humidity the blocks must not exhibit high levels of deliquescence, that is, absorb excessive amounts of moisture. Nonetheless, the blocks must not be so hardened as to make it difficult for livestock to eat from them: livestock must be able to consume the blocks in sufficient quantities so as to promote adequate feeding. Parameters that can be varied to control the stability and texture of the blocks, as well as the nutritional content, include the addition of separator byproducts, including but not limited to lipids, to the syrup mixture; the degree of pressure applied when curing the block; and the relative proportions of distillers solubles, molasses, tallow, and additives such as vitamins, minerals, and protein supplements. Finally, additional components may be added to control the extent of the Maillard reaction and Strecker degradation within the mixture, as these reactions have been known to limit the use of corn-based products in substantial quantities in the manufacture of animal feeds.

The temperature at which the process is carried out can have an impact at various steps. The temperature can be altered during condensation of the syrup mixture to control the rate and extent of water loss. Temperature levels must also be controlled to prevent loss of nutrients and vitamins due to processes such as the Maillard reaction and Strecker degradation. Temperature levels must also be controlled to prevent scorching of the syrup mixture. The viscosity of the mixture will affect how easily it can be poured and formed into blocks and therefore can also be optimized. The syrup mixture preferably has a high viscosity. The viscosity of the syrup mixture increases as the moisture level of the mixture decreases. The pH of the solubles may also be adjusted to reduce the viscosity of the syrup mixture to a desired level.

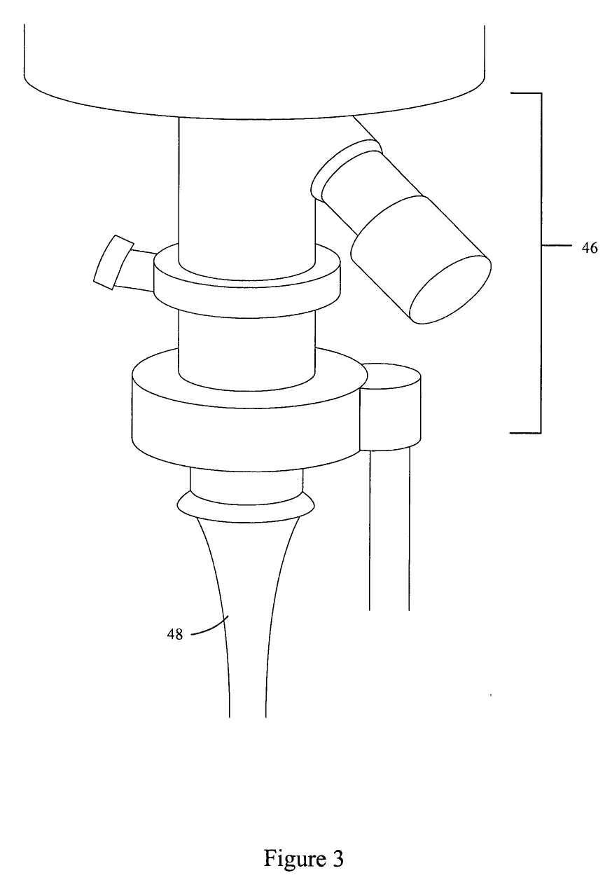

The research-scale block manufacturing plant, indicated at 46 in FIG. 3, includes a steam jacketed kettle with scraped surface agitators, a shell-in-tube preheater/cooker, and electronic temperature and vacuum sensors. The steam jacketed kettle operatures under vacuum or low temperature processing. In the preliminary study, the finished product included a syrup mixture 48 containing fifty percent (50%) condensed distiller's solubles and fifty percent (50%) beet molasses in the wet basis. The cooked basis included approximately twenty-eight percent (28%) distiller's solubles. The texture, color and physical characteristics of the block after cooling was comparable to blocks in which molasses is the sole ingredient.

To maximize the amount of the new protein block (feed block) that each animal consumes, the composition of the blocks can be varied and the resulting preferences of the animals can be monitored to optimize feeding. Among the variables that can be measured in this regard are the animals' preference for the distillers solubles-based blocks compared to other available blocks; variability in how much each animal consumes; consumptive behavior as it changes from one day to the next; and the amount of block material that is consumed when the animals are first introduced to the new blocks compared to the amount such animals consume after extended exposure to the new block material.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method for making protein blocks for livestock feeding, comprising:
(a) providing distillers solubles, molasses, and tallow;
(b) mixing together the distillers solubles, molasses, and tallow, the distillers solubles constitute the primary ingredient of the mixture and the molasses is only a minor constituent of the mixture;
(c) removing water from the mixture of distillers solubles, molasses, and tallow using heat and vacuum, so as to condense the mixture;
(d) combining the condensed mixture of distillers solubles, molasses, and tallow with premixtures of vitamins, minerals, and other nutrients;
(e) pouring the combination of condensed distillers solubles, molasses, tallow and nutrient premixtures into block molds while the combination is still hot; and
(f) cooling the combination in the mold to thereby form protein blocks having distillers solubles as the primary ingredient thereof.

2. The method of claim 1 and further selecting the molasses from a group consisting of:
cane molasses and beet molasses.

3. The method of claim 1 wherein step (c) includes varying the temperature to control the rate and extent of water loss.

4. The method of claim 1 wherein step (c) includes varying the temperature to prevent the loss of nutrients and vitamins.

5. The method of claim 1 and further selecting the other nutrients from a group consisting of: protein supplements and lipids.

6. The method of claim 1 wherein step (b) is performed such that the protein blocks comprise at least fifty percent distiller's solubles by weight.

7. The method of claim 1 wherein step (a) includes providing distillers solubles that are by-products of ethanol production.

8. The method of claim 7 and further selecting the ethanol production from a group consisting of: dry grind ethanol production and wet mill ethanol production.

9. The method of claim 1 and further selecting the distillers solubles from a group consisting of: liquid solubles, condensed distillers solubles, and distillers dried solubles.

10. The method of claim 1 wherein step (a) includes providing distillers solubles that are by-products of the fermentation of grains.

11. The method of claim 11 and further selecting the grains for fermentation from a group consisting of: corn, wheat, barley, sorghum, and rice.

12. The method of claim 1 wherein step (c) includes varying the depth of the vacuum to control the rate and final extent of water loss.

13. The method of claim 1 and further carrying out the method as batch-wise processing.

14. The method of claim 1 and further carrying out the method through continuous flow processing.

15. The method of claim 1 and further distillers solubles replacing molasses as an ingredient with distillers solubles.

16. The method of claim 1 and further varying the pH of the distillers solubles to reduce the viscosity of the mixture.

17. A method for utilizing the output of ethanol production, comprising:
(a) obtaining a distillers by-product from ethanol production; and
(b) using the distillers by-product as the primary ingredient for making protein blocks for livestock feeding.

18. The method of claim 17 and further selecting the the distillers by-product from a group consisting of: liquid solubles, distillers dried solubles, and condensed distillers solubles.

19. The method of claim 18 wherein step (b) comprises:
(i) mixing together the distillers solubles, molasses, and tallow, the distillers solubles constituting the primary ingredient of the mixture and the molasses being only a minor constituent of the mixture;
(ii) removing water from the mixture of distillers solubles, molasses, and tallow using heat and vacuum, so as to condense the mixture;
(iii) combining the condensed mixture of distillers solubles, molasses, and tallow with premixtures of vitamins, minerals, and other nutrients;
(iv) pouring the combination of condensed distillers solubles, molasses, tallow and nutrient premixtures into block molds while the combination is still hot; and
(v) cooling the combination in the mold to thereby form protein blocks having distillers solubles as the primary ingredient thereof.

20. The method of claim 19 and further selecting the molasses from a group consisting of: cane molasses and beet molasses.

21. The method of claim 19 wherein step (ii) includes varying the temperature to control the rate and extent of water loss.

22. The method of claim 19 wherein step (ii) includes varying the temperature to prevent the loss of nutrients and vitamins.

23. The method of claim 19 and further selecting the other nutrients from a group consisting of: protein supplements and lipids.

24. The method of claim 19 and further performing step (i) such that the protein blocks of step (v) comprise at least fifty percent distiller's solubles by weight.

25. The method of claim 19 step (i) includes providing distillers solubles that are by-products of ethanol production.

26. The method of claim 25 and further selecting the ethanol production from a group consisting of: dry grind ethanol production and wet mill ethanol production.

27. The method of claim 1 and further selecting the distillers solubles from a group consisting of: liquid solubles, condensed distillers solubles, and distillers dried solubles.

28. The method of claim 19 wherein the distillers solubles are the by-products of the fermentation of grains.

29. The method of claim 28 and further selecting the grains from a group consisting of: wheat, barley, sorghum, and rice.

30. The method of claim 19 wherein step (i) includes varying the depth of the vacuum to control the rate and final extent of water loss.

31. The method of claim 19 wherein the method is carried out in a batch-wise process.

32. The method of claim 19 wherein the method is carried out through continuous flow processing.

33. The method of claim 19 wherein the distillers solubles replace molasses as an ingredient.

34. The method of claim 19 and further varying the pH of the distillers solubles to reduce the viscosity of the mixture.

35. A method for making protein blocks for livestock feeding, comprising:
(a) providing distillers solubles;
(b) mixing together distillers solubles;
(c) removing water from the mixture of distillers using heat and vacuum, so as to condense said mixture;
(d) combining the condensed mixture of distillers solubles with premixtures of vitamins, minerals, and other nutrients;
(e) pouring the combination of condensed distillers and nutrient premixtures into molds while said combination is still hot; and
(f) cooling the combination to form a protein block.

36. The method of claim 35 wherein step (b) includes mixing together the distiller solubles with molasses and tallow.
